(19) United States
(12) Patent Application Publication
(10) Pub. No.: US 2018/0354151 A1
(43) Pub. Date: Dec. 13, 2018

(54) MAT BOARD WITH CURVED FEATURES

(71) Applicant: David Gallo, Mamaroneck, NY (US)

(72) Inventor: David Gallo, Mamaroneck, NY (US)

(21) Appl. No.: 16/007,516

(22) Filed: Jun. 13, 2018

Related U.S. Application Data
(60) Provisional application No. 62/518,966, filed on Jun. 13, 2017.

(51) Int. Cl. B26F 1/38; B26D 3/02; B26D 1/01; B44C 5/00; G09F 1/12

(52) U.S. Cl. CPC B26F 1/3853; B26F 1/3826; B26D 3/02; B26D 1/0006; B44C 5/005; G09F 1/12; B26D 1/015

(57) ABSTRACT

A mat board is provided and is formed of a body having outer peripheral edges and an inner window formed therein. The inner window is defined by a sloped side wall that extends peripherally around the inner window and extends from a top surface of the body to a bottom surface of the body. The sloped side wall has an exposed convex surface, wherein corners of the inner window have curvature in that the top surface of the body in each corner is curved.

### CROSS REFERENCE TO RELATED APPLICATION

The present application claims priority to and the benefit of U.S. provisional patent application No. 62/518,966, filed Jun. 13, 2017, which is hereby incorporated by reference in its entirety.

### TECHNICAL FIELD

The present invention is directed to picture framing equipment and in particular, is directed to an improved mat board that has curved features and can be made from a wide variety of materials.

### BACKGROUND

CNC machining is a process used in the manufacturing sector that involves the use of computers to control machine tools. The CNC in CNC machining stands for computer numerical control.

Traditional or Classic Mat Design:
When you have a picture frame with rounded edges, the square symmetry of the classic Mat fights the rounded edges on majority of art and the frame itself in a lots of cases.
All or substantially all mats are currently made out of multi-colored paper and cotton, but no other material.
The CNC mat cutting machines designed for the industry to cut mats are only capable to cut paper with blades.
The mat windows are cut with a CNC (computer numerical control) mat cutting machine that makes sharp 90 to 45 degree bevels. The blade passes over the mat creating a cut thru the material creating the bevel window leaving an over cut mark (a line) at the end of each side. In order to extract the remaining material, this process requires the over cut.
The flat beveled edges reflect the ambient light in a more aggressive fashion, highlighting the mat itself, vs. calling attention to the art within the frame.
⅛th of an inch is the thickest mat available because the CNC mat cutter in the industry cannot cut anything thicker than ⅛th of an inch, blades will bend at times if slightly thicker materials (paper and cotton).

### SUMMARY

In accordance with one aspect of the present invention, a mat board is provided and is formed of a body having outer peripheral edges and an inner window formed therein. The inner window is defined by a sloped side wall that extends peripherally around the inner window and extends from a top surface of the body to a bottom surface of the body. The sloped side wall has an exposed convex surface, wherein corners of the inner window have curvature in that the top surface of the body in each corner is curved.

In another aspect of the present invention, a method for forming a mat board comprises the step of: forming an inner window in a mat board substrate by using a cutting bit that forms a sloped side wall that defines the inner window and forms rounded corners of the inner window, the sloped side wall having an exposed convex surface. The step of forming the inner window can comprise cutting a stock sheet of material to form the inner window using a round over V-groove router bit. The router bit is used with a programmable CNC machine.

### BRIEF DESCRIPTION OF THE DRAWING FIGURES

FIG. 1 is a perspective view of a mat board in accordance with one embodiment of the present invention;

FIG. 2 is a cross-sectional view taken along the line 2-2 of FIG. 3;

FIG. 3 is a top plan view of one corner of the mat board;

FIG. 4 is a bottom plan view of one corner of the mat board; and

FIG. 5 is side view showing a tool used in accordance with the present invention to cut the mat board.

### DETAILED DESCRIPTION OF CERTAIN EMBODIMENTS

New Mat Construction:

In accordance with the present invention, a mat board is produced and in at least one embodiment can have the following characteristics:
the product and method of the present invention can create thickness choice options between 1/16″ to 12″ with a variety of materials, including but not limited to:

| | | |
|---|---|---|
| Mat | Stone | Bronze |
| boards (layers | Plexisglass | Brass |
| of cotton) | Rubber | Gold |
| Acrylic | Paper | and |
| Wood | Leather | Glass |
| Polymers | Aluminum | |
| (Plastics) | Steel | |

The present invention uses a CNC Router machine that will create soft rounded corners on the inner window of the Mat in various degrees. The rounded corners will create a smoother and softer appearance to the transition between the frame and the art itself. The rounded design allows the ambient light to disperse more evenly through a variety of angles versus the direct highlighting affect of the flat beveled edges of a classic mat design. This “softening” of the ambient light draws the audience's eyes into the art itself which is the goal in framing along with preserving and protecting the art against ageing.
Typically, mats are used to protect and accentuate the art. In addition to that the present invention offers the prospecting client an opportunity to create design patterns on the mat itself; giving way to a multi-dimensional “art within art” appearance of the entire piece including calligraphy.

### Exemplary Fabrication Process:

### Software Required:

Vcarve Inspire Edition
Uccnc that will run on a personal computer.

### Tools Required:

Computer Numerical Control Machine (CNC) equipped with a spindle with a speed of 5000-35000 RPM.
A single turbine table vacuum system that creates suction from underneath the sacrificial board/bed (location in which one places the mat to be cut) to keep the mat from shifting as the spindle carves the material as well as removing any debris the carving creates.
Automatic tool changing system that allows the spindle to change the routing bits automatically.
The Routing bits required are point cutting round over routing and spiral bits. These bit sizes will vary depending on thickness of the material being cut.

### Exemplary Procedure:

1. Open Vcarve
2. Jobsize (X&Y)=Input dimensions of material being cut.
3. Material Thickness (Z)Axis=Input the material's thickness.
4. XY Datum Position=Input the spindle's starting position.
5. Create vectors=select a vector based on the job type (square, Circle, Rectangle etc).
6. Size=Enter the size of the vector.
7. Tool Path Operations=Select profile tool path
8. Cutting Depth=Enter cutting depth based on thickness of material.
9. Tool=Select tool type for project (round over router, spiral bit etc) based on thickness of material being cut.
10. Feeds And Speeds:
   Spindle speed (RPM of spindle) 5000-24000 RPM.
   Feed Rate=The speed that the spindle moves across the material. 0.5-10 Inches/Min
   Plunge Rate=The Speed in which the spindle plunges into its start point. 0.2-5 Inches/Min
11. Machine Vectors=Where on the vector the spindle is set to carve.
   Outside/Right=The spindle carves outside vector location, SO if the vector were to be a square the spindle would begin carving from the outside of the shape.
   Inside/Left=The spindle carves on the inside of the vector location.
   On=The spindle carves on the exact location of the vector shape.
12. Direction=The direction that the spindle carves/moves around vector.
   Climb=Clockwise
   Conventional=Counterclockwise
13. Save File
14. Open File in Uccnc.
15. Click Start Cycle to begin carving the material.
16. Collect finished products.

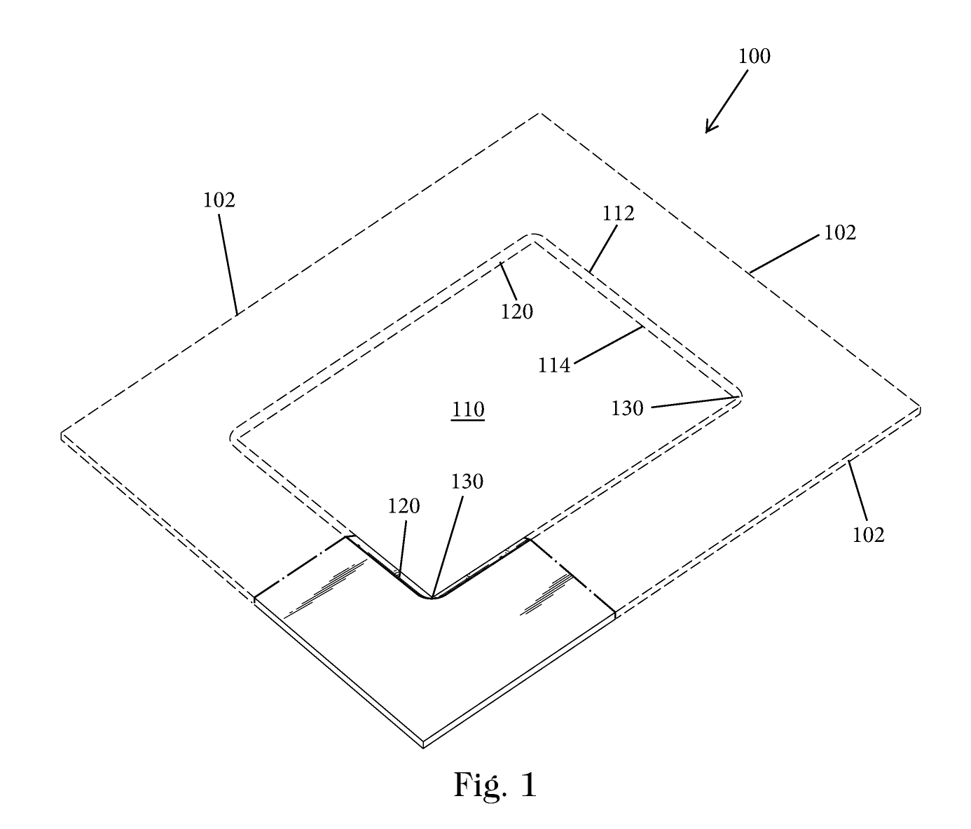

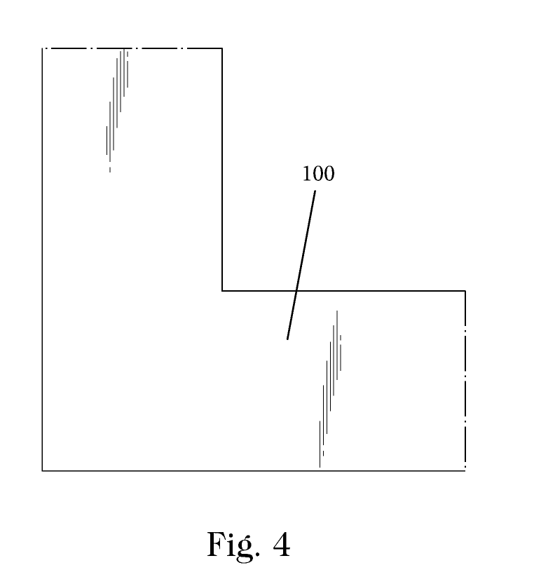

FIGS. 1-4 show a mat board 100 in accordance with at least one embodiment of the present invention, with the broken lines showing one portion of the mat board 100. The mat board 100 can come in any number of different shapes, thicknesses, sizes, etc. The mat board 100 has outer peripheral edges 102 and has an inner window 110 formed therein. The inner window 110 is defined by a top edge 112 and a bottom edge 114 with a side wall or edge 120 being formed between the top edge 112 and the bottom edge 114.

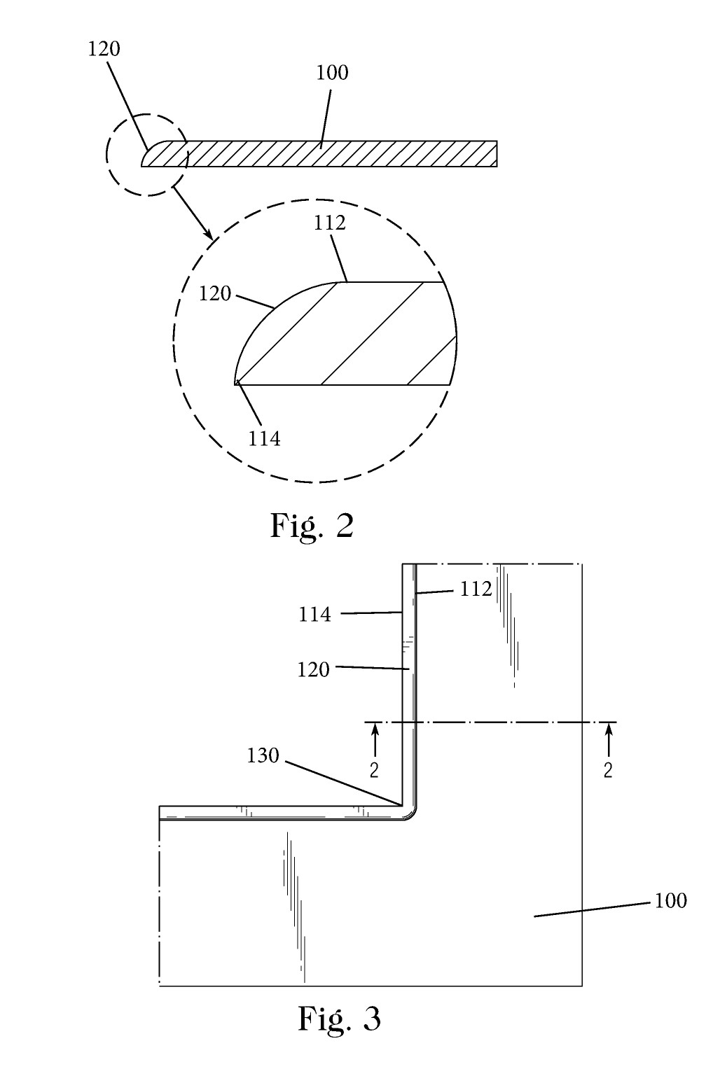

As best shown in FIGS. 2 and 3 and in accordance with the present invention, the mat board 100 has soft rounded corners 130. In particular, the top edge 112 and the side wall 120 itself are curved in each of the soft rounded corners 130 as shown. However, in each of the corners of the inner window 110, the bottom edge 114 defines a right angle (90 degrees) as shown.

In accordance with the present invention, the side wall 120 also has a rounded feature in that in contrast to conventional mat boards that have a flat side wall 120, the side wall 120 has a curved surface. More particularly, the side wall 120 has a convex surface. In other words, the side wall 120 is a downwardly sloping surface that slopes down in the direction of the bottom edge 114.

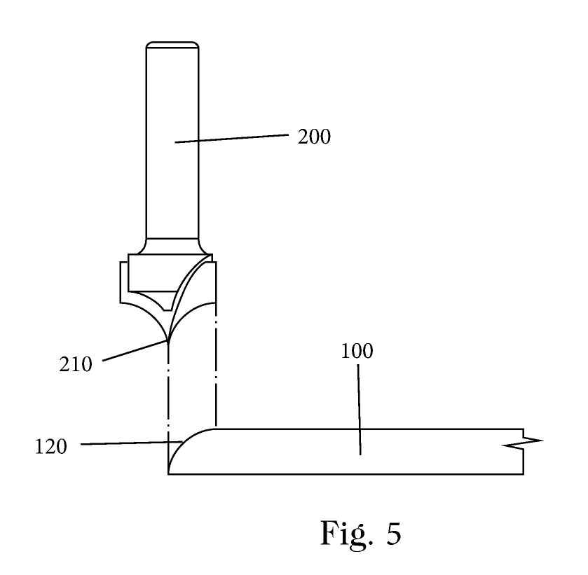

FIG. 5 shows a tool 200 that is used to form the inner window 110 (FIG. 1) according to the process and steps described hereinbefore. The tool 200 is used with a CNC machine that is programmable to cut the inner window 110 in a stock sheet of mat board. The desired specifications of the mat board 100 are typically inputted into the CNC machine to permit the CNC machine to drive the tool 200 along location coordinates that cause the outer exposed edges of the mat board 100 to be formed and also permit the inner window 110 to be formed.

The tool 200 can be a round over V-groove bit that has a tip 210 that is configured to form the soft rounded corners 130 and also create the curved side wall 120.

Applicant has discovered that the speed of the tool 200 does make a difference in terms of producing the mat board 100 having the features described herein. In particular, if the tool 200 operates at too low of a speed (rpm), then the stock sheet may shred, including along the side walls 120 that define the inner window 110. Similarly, if the tool 200 operates at too high of a speed (rpm), then the stock may likewise shred. As set forth herein, if the tool 200 is operated within a target range, such as at a speed of between 5,000 RPM and 24,000 RPM, all of the edges of the mat board 100, including the side walls 120, are properly formed and are in clean shape (no shredded appearance or jagged edges, etc.). In one embodiment, the tool 200 comprises a round over 90 degrees bit or it can also be referred to as being a round over V-groove bit.

As mentioned above, the tool 200 can cut through any number of different materials including but not limited to those disclosed herein. As a result, unlike the conventional techniques which were limited to use of paper media, the fabrication process of the present invention can even use plastic stock materials as the base material into which the contoured opening 110 is formed with the rounded beveled edges as shown in the figures.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A mat board comprising:
a body having outer peripheral edges and an inner window formed therein, the inner window being defined by a sloped side wall that extends peripherally around the inner window and extends from a top surface of the body to a bottom surface of the body, the sloped side wall having an exposed convex surface, wherein corners of the inner window have curvature in that the top surface of the body in each corner is curved.

2. The mat board of claim 1, wherein the bottom surface of the body is formed in each corner of the inner window at a right angle.

3. The mat board of claim 1, wherein a top portion of the sloped side wall is located closer to the outer peripheral edge than a bottom portion of the sloped side wall.

4. The mat board of claim 1, wherein the body is formed of a paper material.

5. The mat board of claim 1, wherein the body is formed of layered cotton.

6. The mat board of claim 1, wherein the body is formed of a plastic material.

7. A method for forming a mat board comprising the step of:
forming an inner window in a mat board substrate by using a cutting bit that forms a sloped side wall that defines the inner window and forms rounded corners of the inner window, the sloped side wall having an exposed convex surface.

8. The method of claim 7, wherein the step of forming the inner window comprises cutting a stock sheet of material to form the inner window using a round over V-groove router bit.

9. The method of claim 8, wherein the router bit is used with a programmable CNC machine.

10. The method of claim 9, wherein the router bit is coupled to a spindle that is operated at a speed between about 5,000 RPM and about 24,000 RPM.

11. The method of claim 10, wherein a plunge rate of the spindle is between about 0.2 inch/min to about 5 inches/min.

12. The method of claim 7, wherein within each corner of the inner window, only a top edge of the side wall has curvature, while a bottom edge of the side wall defines a right angle in each corner.

13. The method of claim 8, wherein the router bit is configured to both form the rounded corners and the sloped side wall.

14. The method of claim 8, wherein the router bit comprises a round over 90 degree router bit.

15. The method of claim 1, wherein the mat board substrate is formed of a paper material.

16. The method of claim 1, wherein the mat board substrate is formed of layered cotton.

17. The method of claim 1, wherein the mat board substrate is formed of a plastic material.

18. A mat board made in accordance with the method of claim 7.
